(19) United States
(12) Patent Application Publication
(10) Pub. No.: US 2013/0175407 A1
(43) Pub. Date: Jul. 11, 2013

(54) Pipe Alignment Device

(71) Applicants: David Williams, Selmer, TN (US); Reese Rhea, Selmer, TN (US)

(72) Inventors: David Williams, Selmer, TN (US); Reese Rhea, Selmer, TN (US)

(21) Appl. No.: 13/348,005

(22) Filed: Jan. 11, 2012

(51) Int. Cl. F16L 3/23

(52) U.S. Cl. 248/68.1

(57) ABSTRACT

A pipe alignment device that enables the placement of water lines to provide stability comprising: a principle C-clasp opening; a first pipe bracket attached to the outer perimeter of the principle C-clasp opening; and a second pipe bracket attached to the outer perimeter of the principle C-clasp opening, where the first pipe bracket and second pipe bracket each include at least one C-clasp opening for receiving a pipe. The first pipe bracket and second pipe bracket each include two C-clasp openings of a second diameter size and the principle C-clasp has a first diameter size. The first diameter size is larger than the second diameter size.

### BACKGROUND OF THE INVENTION

1. Field of Invention

The present invention relates to a pipe alignment device that is used to stabilize and secure water lines.

2. Description of Related Art

Plumbers and contractors must manage the positioning and alignment of pipes under a sink or drain to ensure that the pipes do not interfere with each other and that the pipes are adequately positioned to provide access thereto during the installation and repair thereof. Many times pipes must be bent and shaped in different configurations in order to fit the pipe to the proper position for connection to the faucet or drain water lines. Many times plumbers and construction workers must utilize strap wires and other means to secure the water lines in a sturdy position both during installation and repair of the plumbing work. Consequently, it would be advantageous to have a device that may be used to align and stabilize pipes both during construction and then upon completion of the installation of pipes.

### SUMMARY OF THE INVENTION

The present invention relates to a pipe alignment device that enables the placement of water lines to provide stability comprising: a principle C-clasp opening; a first pipe bracket attached to the outer perimeter of the principle C-clasp opening; and a second pipe bracket attached to the outer perimeter of the principle C-clasp opening, where the first pipe bracket and second pipe bracket each include at least one C-clasp opening for receiving a pipe. The first pipe bracket and second pipe bracket each include two C-clasp openings of a second diameter size and the principle C-clasp has a first diameter size. The first diameter size is larger than the second diameter size.

### BRIEF DESCRIPTION OF DRAWINGS

FIG. 1 depicts a side view of a pipe alignment device in accordance with the present invention.

FIG. 2 depicts a top view of the pipe alignment device according to the present invention.

### DETAILED DESCRIPTION

The present invention relates to a C-clasp pipe alignment device that enables the placement thereof onto water lines to provide stability. The C-clasp alignment device according to the present invention includes a main C-clasp that includes smaller C-clasp attachments to the outer perimeter thereof. The C-clasp device allows for the insertion of pipes and water lines so that they may be stabilized during construction and installation of pipes under a sink or underneath other receptacles.

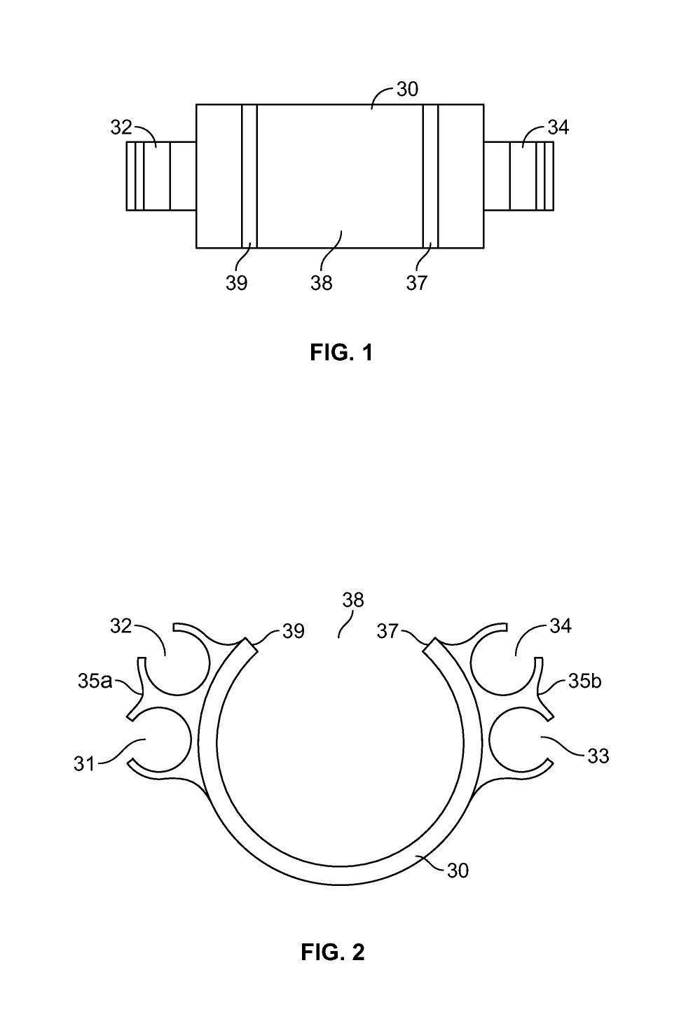

The Pipe Alignment Device 30 according to the present invention is depicted in FIG. 1. FIG. 1 provides a side view of the Pipe Alignment Device 30. The side view shows an Opening 38 that allows for the insertion of a principal pipe such as a drainpipe into the primary C-clasp of the Pipe Alignment Device 30. The Opening 38 of the C-clasp 30 has a First End 39 and a Second End 37. Along the outer perimeter of Pipe Alignment Device 30 are additional C-clasps or smaller C-clasps for attachment of pipes. Opening 32 on one side of the primary C-clasp is shown and the opposite side of Opening 34 is also shown. These openings form smaller C-clasps for the insertion of pipes.

In reference to FIG. 2, a top view of the Pipe Alignment Device 30 is depicted. The top view provides a clear view of the Opening 38 that forms the primary C-clasp of the Pipe Alignment Device 30. Just beyond the First End 39 is a Pipe Bracket 35a. The Pipe Bracket 35a includes Openings 32 and 31. These Openings 32 and 31 form two C-clasps for the insertion of the pipes therein. On the opposite side of the main C-clasp 30 beyond the Second End 37 is Pipe Bracket 35b. Pipe Bracket 35b includes two Openings 34, 33. These Openings 33, 34 provide two additional C-clasps for the insertion of pipes.

During use the primary C-clasp formed with Opening 38 may be fitted around a drainpipe and thus allow for the insertion of additional pipes in the surrounding openings within Pipe Brackets 35a, 35b. Although two pipe brackets are shown with this particular embodiment it is contemplated an additional pipe bracket may be attached to the center portion of the primary C-clasp of the Pipe Alignment Device 30.

The primary C-clasp may have a diameter of about 3.5 inches. The dual C-clasp shown in both Pipe Brackets 35a, 35b may have diameters of about 0.925 inches. Consequently about five water lines may be maintained with this Pipe Alignment Device 30. The Pipe Alignment Device 30 is a single mobile and flexible accessory that helps to maintain the positioning of pipes during installation and construction of pipes under a drain or under other receptacles. The length of Pipe Alignment Device 30 may vary in accordance with various applications used thereon. Further these measurements provide just one particular embodiment of the present invention and other suitable diameters may be utilized in accordance with the overall concept of the Pipe Alignment Device 30 according to the present invention. Use of the pipe alignment device according to the present invention provides a means to expedite installation in a neat and organized manner with the use of a sole alignment device. The instant invention has been shown and described in what it considers to be the most practical and preferred embodiments. It is recognized, however, that departures may be made there from within the scope of the invention and that obvious modifications will occur to a person skilled in the art.

What is claimed is:

1. A pipe alignment device that enables the placement of water lines to provide stability comprising:
a. a principle C-clasp opening;
b. a first pipe bracket attached to the outer perimeter of the principle C-clasp opening; and
c. a second pipe bracket attached to the outer perimeter of the principle C-clasp opening, where the first pipe bracket and second pipe bracket each include at least one C-clasp opening for receiving a pipe.

2. The pipe alignment device according to claim 1, where the first pipe bracket and second pipe bracket each include two C-clasp openings of a second diameter size and the principle C-clasp has a first diameter size.

3. The pipe alignment device according to claim 2, where the first diameter size is larger than the second diameter size.

4. The pipe alignment device according to claim 1, where principle C-clasp includes a first end and a second end.

5. The pipe alignment device according to claim 4, where the first pipe bracket is just beyond the first end and the second pipe bracket is just beyond the second end.

6. The pipe alignment device according to claim 2, where the first diameter size is about 3.5 inches and the second diameter size is about 0.925 inches.
